(19) United States
(12) Patent Application Publication
(10) Pub. No.: US 2025/0075046 A1
(43) Pub. Date: Mar. 6, 2025

(54) TRANSITION METAL OXIDE-BASED, INFRARED SHIELDED, COMPOSITE MATERIAL

(71) Applicant: U.S. Army DEVCOM, Army Research Laboratory, Adelphi, MD (US)

(72) Inventors: Latha Nataraj, Chadds Ford, PA (US); Heather A. Murdoch, Baltimore, MD (US)

(73) Assignee: U.S. Government, as Represented by the Secretary of Army, Adelphi, MD (US)

(21) Appl. No.: 18/950,378

(22) Filed: Nov. 18, 2024

Related U.S. Application Data
(63) Continuation-in-part of application No. 17/108,437, filed on Dec. 1, 2020.

(51) Int. Cl. C08J 7/04; C25D 1/00; G02B 5/20

(52) U.S. Cl. CPC C08J 7/04; C25D 1/00; G02B 5/208

(57) ABSTRACT

A composite structure includes a plurality of laminate layers containing resin reinforced with carbon fiber; and a laminate, also comprising resin reinforced with carbon fiber, coated with a metallic layer integrated with a transition metal oxide that is laid up as a topmost layer of the plurality of laminate layers. The plurality of laminate layers and the coated laminate are cured to form a solid block of integrated composite material in a defined process to (i) integrate the transition metal oxide within the composite material, (ii) utilize transformed magnetic properties of the transition metal oxide to integrate the transition metal oxide into the metallic layer to coat the laminate, and (iii) utilize transformed optical properties of the transition metal oxide to achieve infrared shielding beyond a phase transition temperature of the transition metal oxide.

### CROSS-REFERENCE TO RELATED PATENT APPLICATIONS

This application is a continuation-in-part of U.S. patent application Ser. No. 17/108,437 filed on Dec. 12, 2020 and titled “Transition Metal Oxide-Based, Infrared Shielded Composite Material” which is hereby incorporated by reference herein in its entirety.

### GOVERNMENT INTEREST

The embodiments herein may be manufactured, used, and/or licensed by or for the United States Government without the payment of royalties thereon.

### BACKGROUND

### Technical Field

The embodiments herein generally relate to infrared stealth technologies, and more particularly to suppression of infrared signatures on composite structures used for vehicles and systems.

### Description of the Related Art

With rapid advancements in infrared detection techniques, there is an increasing demand for progress in stealth technologies. Hence, suppression of infrared signatures has become vital to the survivability of military vehicles and systems. Infrared signature suppression techniques currently in practice typically involve modified geometries to provide optical blocking of heated areas as well as power-intense and complex surface cooling mechanisms associated with performance penalties. In applications such as air vehicles, those penalties would include engine backpressure, additional weight, increased drag, higher cost, and complexity. An improvement in any one of these areas, if not all, would be advantageous and serve as an advancement in the industry. Accordingly, a new infrared suppression technique is needed to overcome the limitations of the conventional solutions.

### SUMMARY

In view of the foregoing, an embodiment herein provides a composite structure comprising a plurality of laminate layers comprising resin reinforced with carbon fiber; and a laminate layer, also comprising resin reinforced with carbon fiber, coated with a metallic layer integrated with a transition metal oxide that is laid up as a topmost layer of the plurality of laminate layers, wherein the plurality of laminate layers and the coated laminate layer are cured to form a solid block of composite material in a defined process to (i) integrate the transition metal oxide within the composite material, (ii) utilize transformed magnetic properties of the transition metal oxide to integrate the transition metal oxide into the metallic layer to coat the laminate, and (iii) utilize transformed optical properties of the transition metal oxide to achieve infrared shielding beyond a phase transition temperature of the transition metal oxide. The transition metal oxide may comprise vanadium dioxide (VO₂). The metallic layer may comprise nickel. The defined process may comprise a magnetically or thermally driven electrodeposition process that causes the VO₂ to become embedded into the nickel. The phase transition temperature may be at least 68° C.

Another embodiment provides a method of forming an infrared-shielding composite structure, the method comprising providing a plurality of laminate layers comprising resin reinforced with carbon fiber; coating a laminate, also comprising resin reinforced with carbon fiber, with a metallic layer integrated with a transition metal oxide; setting the coated laminate as a topmost layer of the plurality of laminate layers; and curing the plurality of laminate layers and the coated laminate to form a solid block of composite material in a defined process to (i) integrate the transition metal oxide within the composite material, (ii) utilize transformed magnetic properties of the transition metal oxide to integrate the transition metal oxide into the metallic layer to coat the laminate, and (iii) utilize transformed optical properties of the transition metal oxide to achieve infrared shielding beyond a phase transition temperature of the transition metal oxide.

The composite material may comprise an emissivity of approximately 0.562. The method may comprise coating an exposed upper surface of the laminate with the metallic layer integrated with the transition metal oxide. The coating of the metallic layer integrated with the transition metal oxide onto the laminate may occur in a bath above the phase transition temperature of the transition metal oxide. The method may comprise controlling a temperature of the bath to cause magnetic properties of the transition metal oxide to switch from non-magnetic to magnetic properties at the phase transition temperature of the transition metal oxide. The method may comprise arranging magnets to attract the transition metal oxide to the laminate. The coating of the laminate may occur at a temperature greater than 68° C. The coating of the laminate may occur at a temperature under 120° C.

Another embodiment provides a method of providing infrared shielding in a composite structure, the method comprising providing a plurality of laminate layers comprising resin reinforced with carbon fiber; coating a laminate layer, also comprising resin reinforced with carbon fiber, with a metallic layer integrated with a transition metal oxide as a topmost layer of the plurality of laminate layers; curing the plurality of laminate layers and the coated laminate at a selected temperature to form one solid block of composite material; and using the composite material to suppress temperature dependent infrared radiation emanating from the composite structure.

The method may comprise providing infrared shielding of the composite material beyond a phase transition temperature of the transition metal oxide. The method may comprise utilizing transformed magnetic properties of the transition metal oxide to coat the laminate. The method may comprise utilizing transformed optical properties of the transition metal oxide to achieve infrared shielding beyond a phase transition temperature of the transition metal oxide. The method may comprise increasing a magnetic convection of the transition metal oxide. The method may comprise controlling a temperature during the coating of the laminate to cause magnetic properties of the transition metal oxide to switch from non-magnetic to magnetic properties at the phase transition temperature of the transition metal oxide. The method may comprise controlling a transmittance of an infrared beam emanating from the composite structure.

These and other aspects of the embodiments herein will be better appreciated and understood when considered in conjunction with the following description and the accompanying drawings. It should be understood, however, that the following descriptions, while indicating exemplary embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a schematic diagram illustrating a composite structure, according to an embodiment herein;

FIG. 2 is a schematic diagram illustrating an apparatus used for a coating process for forming the composite structure of FIG. 1, according to an embodiment herein;

FIG. 3A is a flow diagram illustrating a method of forming the infrared-shielding composite structure of FIG. 1, according to an embodiment herein;

FIG. 3B is a flow diagram illustrating a method of coating the laminate of the composite structure of FIG. 1, according to an embodiment herein;

FIG. 3C is a flow diagram illustrating a method of controlling a temperature of a bath used in a coating process of the laminate of the composite structure of FIG. 1, according to an embodiment herein;

FIG. 3D is a flow diagram illustrating a method of attracting the transition metal oxide to the laminate of the composite structure of FIG. 1, according to an embodiment herein;

FIG. 4A is a flow diagram illustrating a method of providing infrared shielding in the composite structure of FIG. 1, according to an embodiment herein;

FIG. 4B is a flow diagram illustrating a method of providing infrared shielding of the composite material of the composite structure of FIG. 1, according to an embodiment herein;

FIG. 4C is a flow diagram illustrating a method of coating the laminate of the composite structure of FIG. 1, according to an embodiment herein;

FIG. 4D is a flow diagram illustrating a method of achieving infrared shielding in the composite structure of FIG. 1, according to an embodiment herein;

FIG. 4E is a flow diagram illustrating a method of controlling properties of the transition metal oxide of the composite structure of FIG. 1, according to an embodiment herein;

FIG. 4F is a flow diagram illustrating a method of controlling the temperature during the coating of the laminate of the composite structure of FIG. 1, according to an embodiment herein;

FIG. 4G is a flow diagram illustrating a method of applying an infrared beam to the composite structure of FIG. 1, according to an embodiment herein;

FIG. 5A is a schematic diagram illustrating an example of the reflectance of an infrared beam from a bare composite;

FIG. 5B is a schematic diagram illustrating an example of the reflectance of an infrared beam from an integrated composite, according to an embodiment herein;

FIG. 5C is a graph illustrating examples of the reflectance from the bare and integrated composites, according to an embodiment herein; and

FIG. 6 is a graph illustrating examples of the infrared transmittance through VO₂-based coatings, according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

It will be understood that when an element or layer is referred to as being “on”, “connected to”, or “coupled to” another element or layer, it may be directly on, directly connected to, or directly coupled to the other element or layer, or intervening elements or layers may be present. In contrast, when an element or layer is referred to as being “directly on”, “directly connected to”, or “directly coupled to” another element or layer, there are no intervening elements or layers present. It will be understood that for the purposes of this disclosure, “at least one of X, Y, and Z” may be construed as X only, Y only, Z only, or any combination of two or more items X, Y, and Z (e.g., XYZ, XYY, XZ, ZY, YZ, XX, YY, ZZ, etc.).

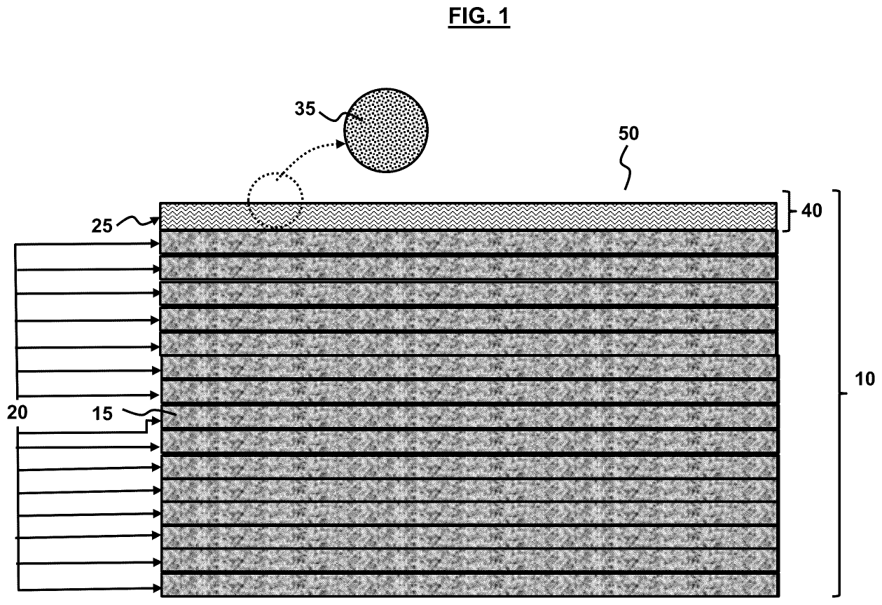

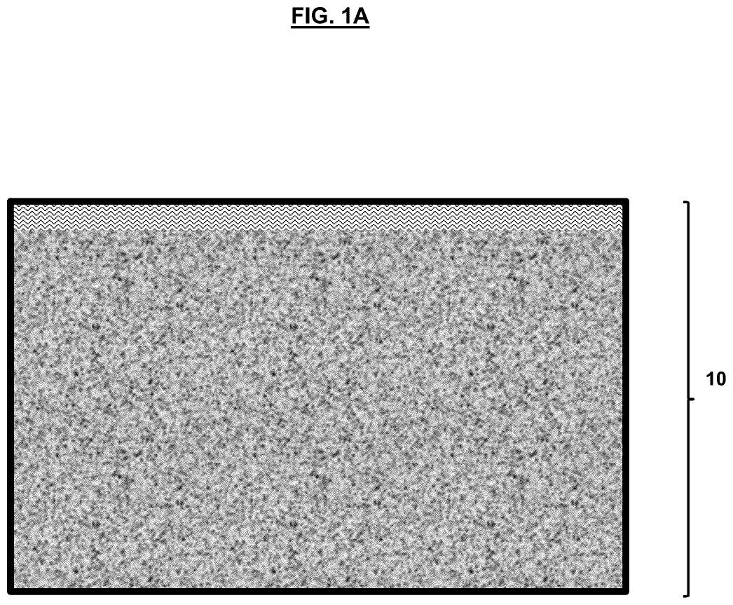

The embodiments herein provide an integrated carbon fiber reinforced polymer (CFRP) composite that is infrared shielded for various structures including aerospace applications. More particularly, the embodiments herein provide an integrated composite embedded with infrared-blocking material to suppress the temperature dependent infrared radiation from the composite structure. The multilayered composite is embedded with a transition material, such as vanadium dioxide (VO₂), which drastically transforms its electrical, optical, and magnetic properties beyond its phase transition temperature of 68° C. to provide infrared shielding beyond the transition temperature. This is accomplished by using a magnetically or thermally driven electrodeposition process to apply a VO₂-containing coating to the laminate comprising resin reinforced with carbon fiber, also called a “prepreg” (a layer of the composite material that has been “pre-impregnated” with a resin system) which is then stacked and cured to form the composite) and integrating this coated prepreg as the topmost layer, embedded within the composite to suppress the temperature dependent infrared radiation from the solid block of integrated composite structure to shield from or confuse thermal-detection-systems/thermal-cameras trying to detect the structure. Moreover, the process could be extended to coat multiple laminates, in addition to the topmost layer, in the composite to enhance performance. The embodiments herein provide stealth in the infrared regime and provide an efficient alternative to the complex and expensive mechanisms conventionally being used for reducing surface temperatures as well as coatings with limited effectiveness and issues such as bonding, interactions with other commonly used protective coatings, and degradation. Referring now to the drawings, and more particularly to FIGS. 1 through 6, where similar reference characters denote corresponding features consistently throughout the figures, there are shown preferred embodiments. In the drawings, the size and relative sizes of components, layers, and regions, etc. may be exaggerated for clarity.

FIG. 1 illustrates a composite structure 10 comprising a plurality of laminate layers 15 comprising resin reinforced with carbon fiber 20. The number of layers constituting the plurality of laminate layers 15 may depend on the particular application for the composite structure 10. According to an example, there may be sixteen layers in the plurality of laminate layers 15. However, the embodiments herein are not restricted to any particular number of layers in the plurality of laminate layers 15. Moreover, the individual layers in the plurality of layers 15 may have the same thickness as one another or they may be different from one another. In some examples, the individual layers in the plurality of layers 15 may comprise a thickness ranging between approximately 0.5-3 mm. However, the embodiments herein are not restricted to any particular thickness for the plurality of layers 15. Furthermore, the overall thickness of the plurality of laminate layers 15 may be selected according to the particular application for the composite structure 10. In an example, the resin reinforced with carbon fiber 20 comprises CFRP, which provides a sufficient rigidity and material strength to the plurality of laminate layers 15, while maintaining a relatively low weight for the overall composite structure 10.

The composite structure 10 further comprises a laminate 25, also comprising resin reinforced with carbon fiber, coated with a metallic layer 30 integrated with a transition metal oxide 35 that is laid up as a topmost layer 40 of the plurality of laminate layers 15. The laminate 25 may comprise an exposed upper surface 50, before the entire stack of laminates is cured as one solid block of integrated composite. According to an example, the metallic layer 30 may comprise nickel. However, other suitable metallic materials may be used in accordance with the embodiments herein. In an example, the transition metal oxide 35 may comprise VO₂. In other examples, the transition metal oxide 35 may comprise other materials such as, but not limited to Ti₂O₃, VO, V₂O₅, V₂O₃, V₃O₇, V₄O₉, V₆O₁₃, V₄O₇, V₅O₉, V₆O₁₁, V₇O₁₃, V₈O₁₅, V₃O₅, FeO, α-Fe₂O₃, NiO, CoO, Co₃O₄, Mn₃O₄, γ-Fe₂O₃, Y₂O₃, TiO₂, CrO₃, and AgO.

The plurality of laminate layers 15 and the coated laminate 25 are cured to form a solid block of composite material 45 in a defined process to (i) integrate the transition metal oxide 35 within the composite material 45, (ii) utilize transformed magnetic properties of the transition metal oxide 35 to integrate the transition metal oxide 35 into the metallic layer 30 to coat the laminate 25, and (iii) utilize transformed optical properties of the transition metal oxide 35 to achieve infrared shielding beyond a phase transition temperature of the transition metal oxide 35. In an example, the composite material 45 may comprise an emissivity of approximately 0.562. However, the emissivity may be different depending on the type of materials used for the plurality of laminate layers 15 and the transition metal oxide 35.

The curing process integrates the plurality of laminate layers 15 with the coated laminate 25 as a single block of composite material 45. However, the coated laminate 25 remains the topmost layer 40 within the overall solid block of composite material 45. Additionally, the curing process integrates the plurality of laminate layers 15 into one solid block of continuous composite. Since the coated laminate 25 is integrated within the overall solid block of composite material 45, the issue with interactions with commonly used coatings (such as a chemical agent resistant coating (CARC)) is non-existent. The topmost layer 40 containing the coated laminate 25, now embedded within the solid block of the composite, provides the infrared shielding for the composite material 45.

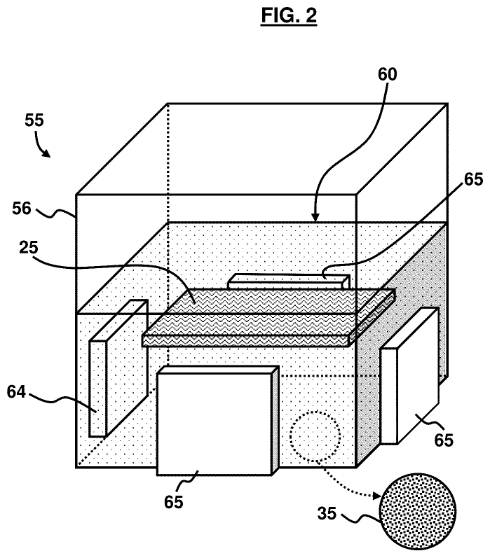

FIG. 2, with reference to FIG. 1, illustrates an example apparatus 55 used for the coating of the laminate layer 25 to be embedded within the solid block of composite structure 10. The apparatus 55 may comprise any suitable type of container such as an electrochemical cell 56 comprising a bath 60 such as an electrodeposition bath containing metal salt electrolytes and a transition metal oxide 35. Magnets 65 may be used to attract the transition metal oxide 35 to the laminate 25. In an example, the magnets 65 may be used to increase the convection of the bath 60 and transition metal oxide 35 in the bath 60. As shown in FIG. 2, the magnets 65 may be positioned outside the electrochemical cell 56. However, in other examples, the magnets 65 may be positioned inside the bath 60. Moreover, there may be any number of magnets 65 used in accordance with the embodiments herein. In some examples, the magnets 65 may comprise any of electromagnets and permanent magnets. The defined process may comprise a magnetically or thermally driven electrodeposition process that causes the transition metal oxide 35 (e.g., VO₂, etc.) to become embedded into the metallic layer 30 (e.g., nickel, etc.). In an example, the phase transition temperature may be at least 68° C. when the transition metal oxide 35 comprises VO₂. However, the phase transition temperature may be different depending on the type of material of the transition metal oxide 35.

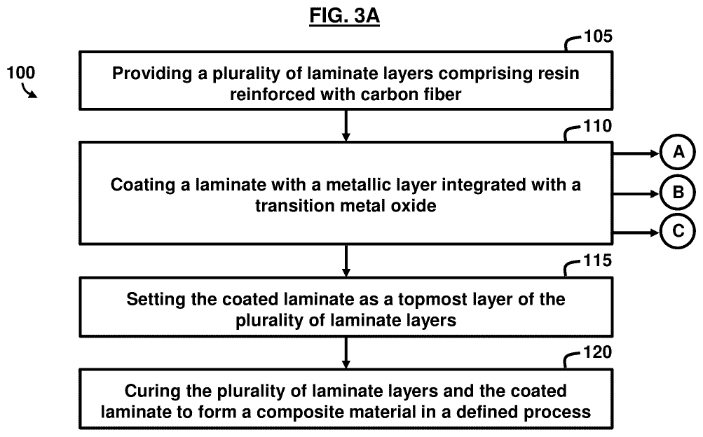

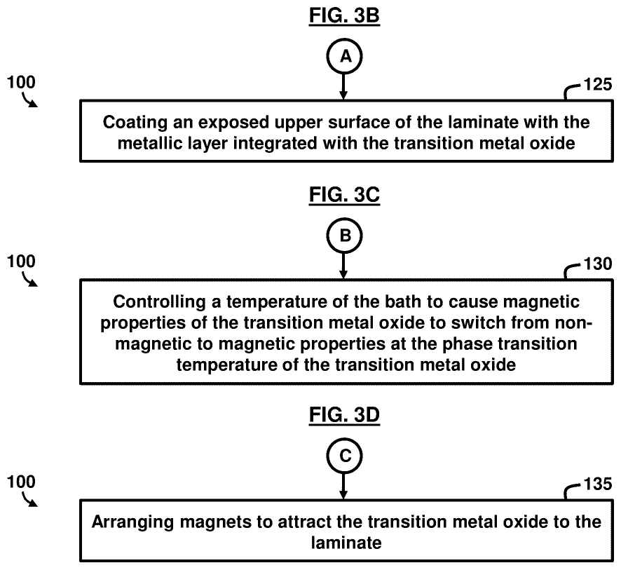

FIGS. 3A through 3D, with reference to FIGS. 1 through 2, are flow diagrams illustrating a method 100 of forming an integrated infrared-shielding composite structure 10. As shown in FIG. 3A, the method 100 comprises providing (105) a plurality of laminate layers 15 comprising resin reinforced with carbon fiber 20. Next, the method 100 comprises coating (110) a laminate 25, also comprising resin reinforced with carbon fiber 20 and coated with a metallic layer 30 integrated with a transition metal oxide 35. Thereafter, the method 100 comprises setting (115) the coated laminate 25 as a topmost layer 40 of the plurality of laminate layers 15 using a typical laying up process. In an example, the coating of the metallic layer 30 integrated with the transition metal oxide 35 onto the laminate 25 may occur in a bath 60 above the phase transition temperature of the transition metal oxide 35. For example, the metallic layer 30 may comprise nickel and the transition metal oxide 35 becomes integrated in the metallic layer 30 during an electroplating process in the bath 60. From a coating processing perspective, the conductivity of one layer (e.g., the laminate 25) is better than a combination of layers (e.g., the plurality of laminate layers 15), and thus the laminate 25 is more likely to be evenly coated during the electroplating process in the bath 60. Further, the dimensions of one layer (e.g., the laminate 25) relative to the electrodeposition cell 56 may be far easier to work with compared with the laminate 25 with the plurality of laminate layers 15. Furthermore, the electrodeposition bath 60 is also acidic, so there is no reason to expose the plurality of laminate layers 15 to the bath 60, but rather only laminate 25.

Thereafter, the method 100 comprises curing (120) the plurality of laminate layers 15 and the coated laminate 25 to form a solid block of composite material 45 in a defined process to (i) integrate the transition metal oxide 35 within the composite material 45, (ii) utilize transformed magnetic properties of the transition metal oxide 35 to integrate the transition metal oxide 35 into the metallic layer 30 to coat the laminate 25, and (iii) utilize transformed optical properties of the transition metal oxide 35 to achieve infrared shielding beyond a phase transition temperature of the transition metal oxide 35. In an example, the curing temperature may be in the range of 20-120° C. depending on the type of materials used for the plurality of laminate layers 15 and the transition metal oxide 35, as well as the thickness of the plurality of laminate layers 15 and the coated laminate 25.

As shown in FIG. 3B, the method 100 may comprise coating (125) an exposed upper surface 50 of the laminate 25 with the metallic layer 30 integrated with the transition metal oxide 35. This process may occur during the electrodeposition that takes place in the bath 60 such that only the upper surface 50 of the laminate 25 is coated with the metallic layer 30 integrated with the transition metal oxide 35. Moreover, the upper surface 50 of the laminate 25 may serve as the outermost embedded layer within-the solid block of integrated composite structure 10 as used in any type of application where infrared shielding of the composite structure 10 is desired. In an example, the thickness of the upper surface 50 may be coincident to the thickness of the topmost layer 40 of the composite material 45.

As shown in FIG. 3C, the method 100 may comprise controlling (130) a temperature of the bath 60 to cause magnetic properties of the transition metal oxide 35 to switch from non-magnetic to magnetic properties at the phase transition temperature of the transition metal oxide 35. In this regard, the transition metal oxide 35 may initially have non-magnetic properties. However, once the phase transition temperature of the transition metal oxide 35 is reached (e.g., by raising the temperature of the bath 60), the transition metal oxide 35 undergoes a phase transition such that its initial non-magnetic properties become magnetic properties. In an example, the coating of the laminate 25 may occur at a temperature greater than 68° C. In another example, the coating of the laminate 25 may occur at a temperature under 120° C.

As shown in FIG. 3D, the method 100 may comprise arranging (135) magnets 65 to attract the transition metal oxide 35 to the laminate 25. More particularly, the transition metal oxide 35 that is integrated in the metallic layer 30 becomes attracted to the laminate 25 during this process. According to an example, the magnets 65 may be used together with the coating process that occurs in the bath 60. However, the embodiments herein are not restricted to using a bath 60 to coat the laminate 25 with the metallic layer 30 integrated with the transition metal oxide 35. Therefore, the magnets 65 may be used to attract the transition metal oxide 35 to the laminate 25 independent of the bath 60. When used together with the bath 60, the magnets 65 may be placed within the bath 60 or outside of the electrochemical cell 56 containing the bath 60.

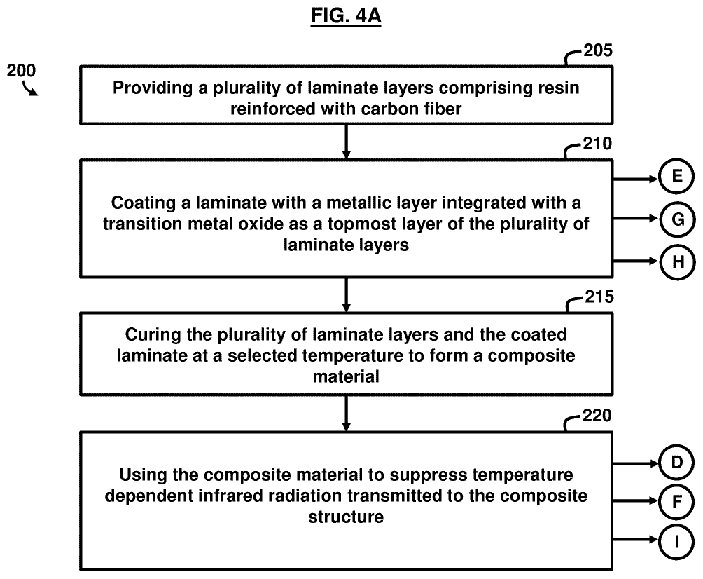

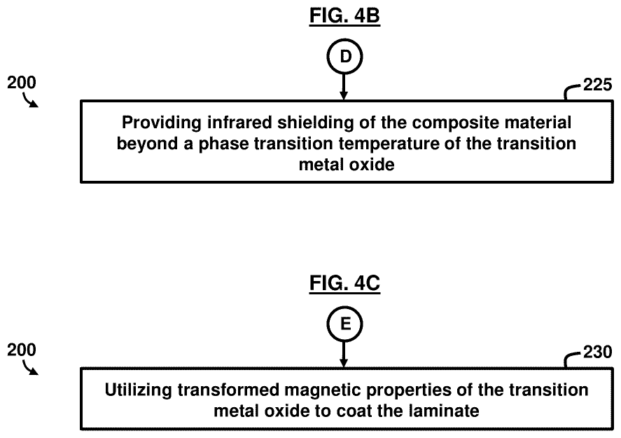

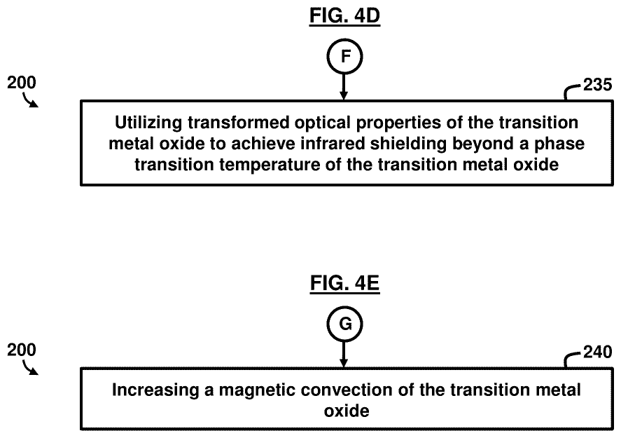

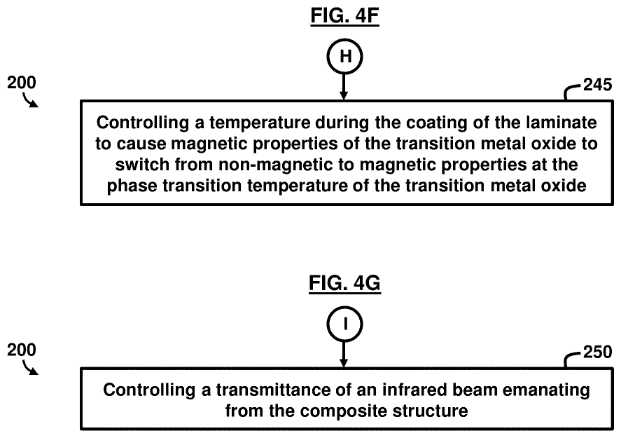

FIGS. 4A through 4G, with reference to FIGS. 1 through 3D, are flow diagrams illustrating a method 200 of providing infrared shielding in an integrated composite structure 10. As shown in FIG. 4A, the method 150 comprises providing (205) a plurality of laminate layers 15 comprising resin reinforced with carbon fiber 20; coating (210) a laminate 25, also comprising resin reinforced with carbon fiber 20, with a metallic layer 30 integrated with a transition metal oxide 35 as a topmost layer 40 of the plurality of laminate layers 15; curing (215) the plurality of laminate layers 15 and the coated laminate 25 at a selected temperature to form a solid block of integrated composite material 45; and using (220) the composite material 45 to suppress temperature dependent infrared radiation emanating from the integrated composite structure 10. The coating (210) of the laminate 25 with the metallic layer 30 integrated with the transition metal oxide 35 may occur as part of an electrodeposition process. In this regard, the electrodeposition process results in the transition metal oxide 35 (e.g., such as VO₂, etc.) embedded into the metallic layer 30 (e.g., containing nickel, etc.), such that the incorporation of the transition metal oxide 35 may be increased over a conventional electrodeposition process by increasing the temperature of the electrodeposition bath 60 above the phase transition temperature of the transition metal oxide 35 (e.g., which may be 68° C. for VO₂) and/or adding one or more small magnets 65 adjacent to the electrochemical cell 56 containing the bath 60, or in the bath 60 itself, in order to increase magnetic convection by utilizing the switching of the material properties of the transition metal oxide 35 from non-magnetic to magnetic at the phase transition temperature.

As shown in FIG. 4B, the method 200 may comprise providing (225) infrared shielding of the integrated composite material 45 beyond a phase transition temperature of the transition metal oxide 35. In an example, the transition metal oxide 35 may comprise VO₂ and have a phase transition temperature of 68° C. As shown in FIG. 4C, the method 200 may comprise utilizing (230) transformed magnetic properties of the transition metal oxide 35 to coat the laminate 25. In this regard, the magnetic properties of the transition metal oxide 35 may transform from non-magnetic to magnetic once the phase transition temperature of the transition metal oxide 35 has been reached. As shown in FIG. 4D, the method 200 may comprise utilizing (235) transformed optical properties of the transition metal oxide 35 to achieve infrared shielding beyond a phase transition temperature of the transition metal oxide 35. In this regard, the emissivity of the transition metal oxide 35 may transform (e.g., decrease) once the phase transition temperature of the transition metal oxide 35 has been reached. In an example, the integrated composite material 45 may comprise an emissivity of approximately 0.562 once the transition metal oxide 35 has reached its phase transition temperature. However, other emissivity values may be achieved depending on the type of material used for the transition metal oxide 35, among other factors that may affect the emissivity values.

As shown in FIG. 4E, the method 200 may comprise increasing (240) a magnetic convection of the transition metal oxide 35 using magnets 65. As shown in FIG. 4F, the method 200 may comprise controlling (245) a temperature (e.g., by raising the temperature of the bath 60) during the coating of the laminate 25 to cause magnetic properties of the transition metal oxide 35 to switch from non-magnetic to magnetic properties at the phase transition temperature of the transition metal oxide 35. As shown in FIG. 4G, the method 200 may comprise controlling (250) a transmittance of infrared radiation emanating from the integrated composite structure 10. In this regard, the transmittance levels may be reduced as a result of incorporation of the coated laminate 25 within the integrated composite structure 10 compared to a structure that does not contain an embedded coated laminate 25 (e.g., a bare composite) as its topmost layer 40.

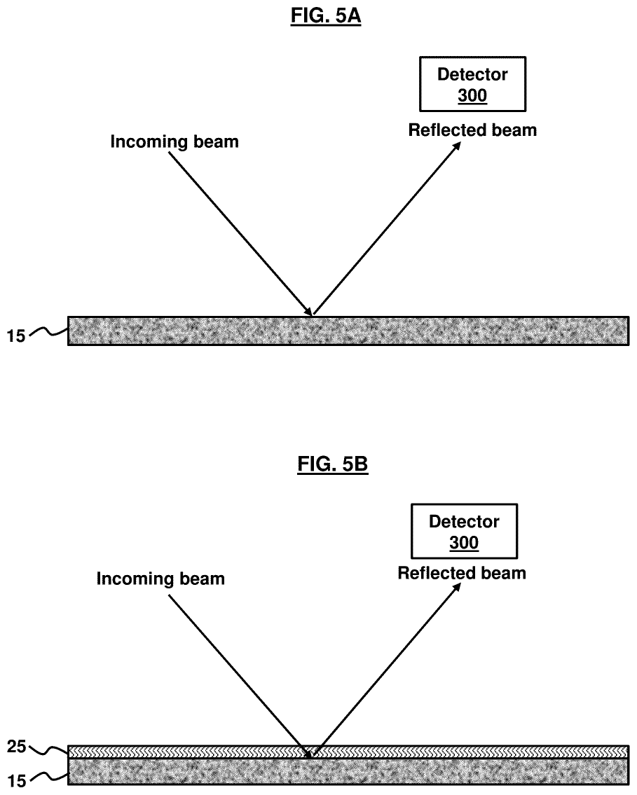

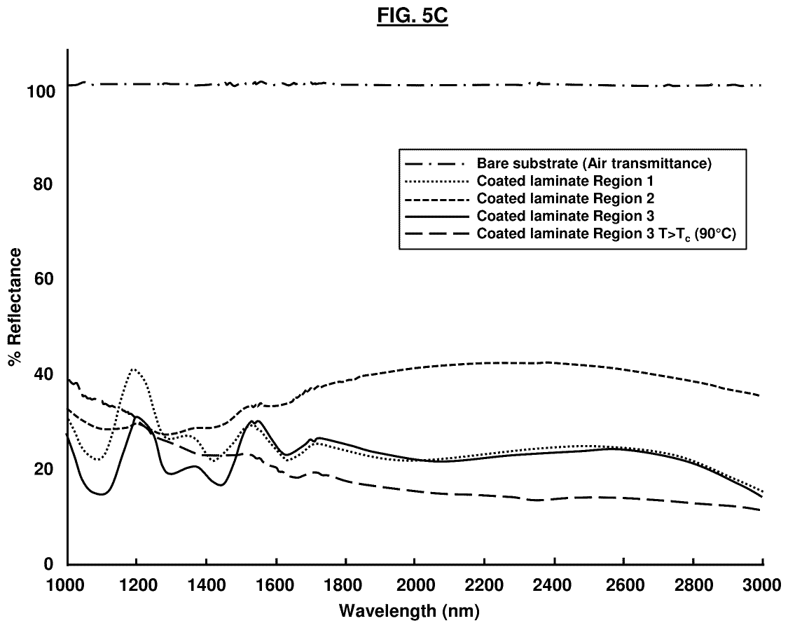

Reflectance-based transmittance Fourier-transform infrared spectroscopy (FTIR) measurements may be experimentally conducted to measure the amount of infrared radiation that would be transmitted through the embedded coated laminate 25 in the near infrared region. This is helpful, as it can provide a good understanding of how much of the temperature-based infrared radiation would escape the embedded coated laminate 25 of the integrated composite structure 10 to be captured by an infrared detection system, such as a thermal camera. FIGS. 5A and 5B, with reference to FIGS. 1 through 4G, illustrate examples of the reflectance of an infrared beam from a bare composite structure (e.g., a conventional structure) and an integrated composite structure 10. A detector 300, such as a thermal camera and/or spectrometer, may be used to measure the reflectance of the infrared beam as well as detected temperatures of the bare composite and the integrated composite structure 10 that is fabricated in accordance with the embodiments herein.

FIG. 5C, with reference to FIGS. 1 through 5B, is a graph illustrating experimental examples of the reflectance from a bare composite structure (e.g., a conventional structure) and an integrated composite structure 10. The bare composite indicates a 100% reflectance to the incoming infrared beam. The integrated composite structure 10 is then placed in the path of an infrared beam to measure the percent of the infrared beam reflected, in comparison with the bare composite. Different regions (R1, R2, and R3) of the integrated composite structure 10 are measured in the experiment. As seen in FIG. 5C, the measured reflectance from the integrated composite structure 10 demonstrate a substantial decrease in the reflectance of the infrared beam, as it passes through the embedded coated laminate 25, hits the plurality of laminate layers 15 comprising the composite material 45, gets reflected back, passes through the embedded coated laminate 25 again, and is directed back to be measured by the detector 300.

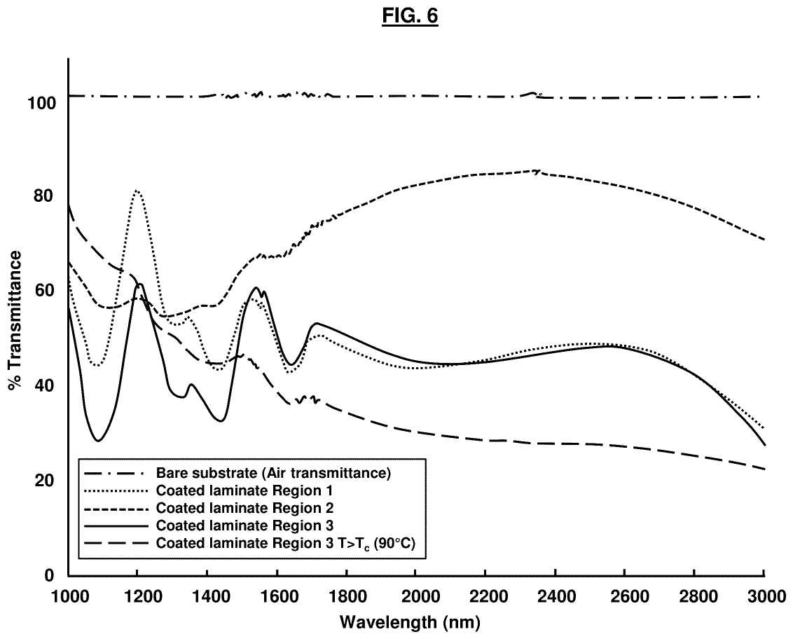

FIG. 6, with reference to FIGS. 1 through 5C, is a graph illustrating experimental examples of the infrared transmittance through the embedded coated laminate 25, according to an embodiment herein. The transmittance of the coated laminate 25 is measured, accounting for the infrared beam going through the embedded coated laminate 25 twice for this measurement. The bare composite measurement essentially indicates a 100% transmittance through the air above and the transmittance of the integrated composite structure 10 for the different regions (R1, R2, and R3) measured and for the temperature above the phase transition temperature (T_{c}) are as illustrated in FIG. 6. As indicated, the transmittance of the infrared beam is substantially lower for the integrated composite structure 10 compared to the bare composite. Additionally, up to the phase transition temperature, the temperature suggested by the infrared beam captured by the detector 300 is the same as the actual temperature of the composite structure 10. Beyond the phase transition temperature, the infrared camouflage effect of the transition metal oxide 35 is activated. Therefore, while the bare composite registers the actual temperature of the composite, the integrated composite structure 10 indicates a lower temperature, essentially fooling the detector 300 into detecting that the integrated composite structure 10 is cooler than the actual temperature.

Table 1 summarizes the emissivity of the bare composite and integrated composite structure 10, % Reflectance (% R), and % Transmittance (% T) obtained for the bare composite and the reduced values recorded for the integrated composite structure 10 provided by the embodiments herein at regions R1, R2, and R3 for different wavelengths and above the phase transition temperature T_{c} of 68° C. for a transition metal oxide 35 comprising VO₂., as illustrated in FIG. 6.

TABLE 1
Reflectance and Transmittance Experimental Values

| | | Integrated Composite Structure 10 | | |
|---|---|---|---|---|
| Emissivity | Bare | 1 μm | 2 μm | 3 μm |

| Wavelength | 0.85 | R1 | R2 | R3 | >T_{c} | R1 | R2 | R3 | >T_{c} | R1 | R2 | R3 | >T_{c} |
|---|---|---|---|---|---|---|---|---|---|---|---|---|---|
| % R | 100 | 30.9 | 33.1 | 27.6 | 39 | 22 | 41 | 22.7 | 15.3 | 15.4 | 35.3 | 13.9 | 11.4 |
| % T | 100 | 61.8 | 66.2 | 55.5 | 78.4 | 44.1 | 82 | 45.4 | 30.6 | 30.7 | 70.8 | 28.3 | 23 |
| | (Air) | | | | | | | | | | | | |

The embodiments herein provide an integrated infrared blocking composite structure 10 that provides an effective solution for infrared shielding by suppressing infrared signatures by reducing the temperature dependent infrared radiation to shield from or confuse adversarial thermal detection systems. The embodiments herein provide stealth in the infrared regime by embedding a transition metal oxide 35, such as VO₂, in the topmost layer 40 of a plurality of laminate layers 15, which is then processed with a curing procedure to render a solid block of integrated infrared-shielded aerospace-grade composite material 45. The embodiments herein utilize the crystallographic change in the transition metal oxide 35 beyond the phase transition temperature that results in a transformation of the magnetic properties of the transition metal oxide 35 to achieve integration of the transition metal oxide 35 into the metallic layer 30 with the laminate 25 and the transformation in the optical properties of the transition metal oxide 35 to achieve infrared shielding capability in the composite material 45. In an example, the composite material 45 may be used as an aerospace-grade composite structure 10. The composite structure 10 can replace conventional complex, costly, and heavy structural design modifications used for reducing surface temperatures to hide from thermal detection systems. Moreover, the integrated composite structure 10 can also replace conventional infrared blocking coatings which have limited effectiveness as they operate in narrower bands of the electromagnetic spectrum and also raise the issues of bonding, interactions with other commonly used protective coatings, and degradation.

The embodiments herein achieve several efficiencies unrealized by the conventional solutions such as providing a low temperature coating process, allowing for the integration into a composite lay-up process, providing an effective infrared shielding solution in the mid-infrared region, providing an inexpensive and scalable technique, and requiring less transition metal oxide 35 than a full (sputtered coating) technique. Additionally, there are several applications for the embodiments herein including the suppression of infrared signatures in the integrated composite materials and structures to shield from or confuse adversarial thermal detection systems/thermal cameras, providing stealth in the infrared regime which is vital for the survivability of military vehicles and systems. Moreover, the embodiments herein may be used in optical/electrical/magnetic switching devices, laser protection, smart windows, temperature regulation in green houses, multifunctional composites to include infrared sensing and energy harvesting, among other uses.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

What is claimed is:

1. An integrated composite structure comprising:
a plurality of laminate layers comprising resin reinforced with carbon fiber; and
a laminate, also comprising resin reinforced with carbon fiber, coated with a metallic layer integrated with a transition metal oxide that is laid up as a topmost layer of the plurality of laminate layers,
wherein the plurality of laminate layers and the coated laminate are cured to form a solid block of integrated composite material in a defined process to (i) integrate the transition metal oxide within the composite material, (ii) utilize transformed magnetic properties of the transition metal oxide to integrate the transition metal oxide into the metallic layer to coat the laminate, and (iii) utilize transformed optical properties of the transition metal oxide to achieve infrared shielding beyond a phase transition temperature of the transition metal oxide.

2. The composite structure of claim 1, wherein the transition metal oxide comprises vanadium dioxide (VO₂).

3. The composite structure of claim 2, wherein the metallic layer comprises nickel.

4. The composite structure of claim 3, wherein the defined process comprises a magnetically or thermally driven electrodeposition process that causes the VO₂ to become embedded into the nickel.

5. The composite structure of claim 1, wherein the phase transition temperature is at least 68° C.

6. A method of forming an infrared-shielded composite structure, the method comprising:
providing a plurality of laminate layers comprising resin reinforced with carbon fiber;
coating a laminate, also comprising resin reinforced with carbon fiber, with a metallic layer integrated with a transition metal oxide;
setting the coated laminate as a topmost layer of the plurality of laminate layers; and
curing the plurality of laminate layers and the coated laminate to form a solid block of integrated composite material in a defined process to (i) integrate the transition metal oxide within the composite material, (ii) utilize transformed magnetic properties of the transition metal oxide to integrate the transition metal oxide into the metallic layer to coat the laminate, and (iii) utilize transformed optical properties of the transition metal oxide to achieve infrared shielding beyond a phase transition temperature of the transition metal oxide.

7. The method of claim 6, wherein the composite material comprises an emissivity of approximately 0.562.

8. The method of claim 6, comprising coating an exposed upper surface of the laminate with the metallic layer integrated with the transition metal oxide.

9. The method of claim 6, wherein the coating of the metallic layer integrated with the transition metal oxide onto the laminate occurs in a bath above the phase transition temperature of the transition metal oxide.

10. The method of claim 9, comprising controlling a temperature of the bath to cause magnetic properties of the transition metal oxide to switch from non-magnetic to magnetic properties at the phase transition temperature of the transition metal oxide.

11. The method of claim 9, comprising arranging magnets to attract the transition metal oxide to the laminate.

12. The method of claim 6, wherein the coating of the laminate occurs at a temperature greater than 68° C.

13. The method of claim 6, wherein the coating of the laminate occurs at a temperature under 120° C.

14. A method of providing infrared shielding in a composite structure, the method comprising:
providing a plurality of laminate layers comprising resin reinforced with carbon fiber;
coating a laminate, also comprising resin reinforced with carbon fiber, with a metallic layer integrated with a transition metal oxide as a topmost layer of the plurality of laminate layers;
curing the plurality of laminate layers and the coated laminate at a selected temperature to form a solid block of integrated composite material; and
using the composite material to suppress temperature dependent infrared radiation transmitted to the composite structure.

15. The method of claim 14, comprising providing infrared shielding of the composite material beyond a phase transition temperature of the transition metal oxide.

16. The method of claim 14, comprising utilizing transformed magnetic properties of the transition metal oxide to coat the laminate.

17. The method of claim 14, comprising utilizing transformed optical properties of the transition metal oxide to achieve infrared shielding beyond a phase transition temperature of the transition metal oxide.

18. The method of claim 14, comprising increasing a magnetic convection of the transition metal oxide.

19. The method of claim 14, comprising controlling a temperature during the coating of the laminate to cause magnetic properties of the transition metal oxide to switch from non-magnetic to magnetic properties at the phase transition temperature of the transition metal oxide.

20. The method of claim 14, comprising controlling a transmittance of an infrared beam emanating from the integrated composite structure.
